(19) United States
(12) Patent Application Publication
(10) Pub. No.: US 2011/0149073 A1
(43) Pub. Date: Jun. 23, 2011

(54) METHOD OF MONITORING PRODUCT IDENTIFICATION AND APPARATUS THEREFOR

(75) Inventor: Peter allan Stothers, Birkenhead (NZ)

(73) Assignee: Zenith Asset Management Limited, Auckland (NZ)

(21) Appl. No.: 12/741,806

(22) PCT Filed: Aug. 13, 2008
(86) PCT No.: PCT/NZ2008/000209

§ 371 Date: Mar. 11, 2011

(30) Foreign Application Priority Data
Nov. 6, 2007 (NZ) 563215

(51) Int. Cl. H04N 7/18; G06K 9/00

(52) U.S. Cl. 348/143; 382/103; 348/E07.085

(57) ABSTRACT

A method of monitoring product identification at a transaction terminal by sending either visible light signals, near infra-red light signals or wireless signals to a recording device that records video footage of a transaction terminal in conjunction received product identification information. A system for effecting the method along with light based and wireless transmitting units are disclosed.

### FIELD OF THE INVENTION

This invention relates to a method of monitoring product identification at a transaction terminal. More particularly, but not exclusively, the invention relates to a method of monitoring product identification at a transaction terminal by sending a signal indicating product identification to be recorded in combination with video footage of the transaction terminal.

### BACKGROUND OF THE INVENTION

In order to reduce shrinkage from retail outlets many retailers have installed surveillance cameras to monitor staff at transaction terminals. However, staff can defeat such measures by apparently scanning an item but in fact preventing the reading of a product (by placing their hand over the bar code or orienting the bar code away from the reader) so that an accomplice receives an item without paying for it. The video footage will appear to show a normal scan and so will not detect this dishonesty. It is desirable that monitoring be covert to avoid detection and distraction.

It would be desirable to provide a method for detecting such dishonesty and apparatus for performing the method or to at least provide the public with a useful choice.

### Exemplary Embodiments

According to one exemplary embodiment there is provided a method of monitoring product identification at a transaction terminal comprising:
a. identifying a product using a reader at a transaction terminal;
b. recording video footage of the reading of the product at the transaction terminal;
c. covertly sending information indicating product identification to a remote recording device; and
d. recording the video footage at the remote recording device in combination with information indicating product identification.

According to a further exemplary embodiment there is provided a transaction terminal monitoring system comprising:
a. a video recording device for recording video footage of a transaction terminal;
b. a wireless transmitter configured to send a wireless signal indicating product identification upon receipt of product identification information from a reader; and
c. a wireless receiver configured to receive product identification information signals from the wireless transmitter, wherein the system is configured to superimpose product identification information on recorded video footage.

According to another exemplary embodiment there is provided a transaction terminal monitoring system comprising:
a. a video recording device for recording video footage of a transaction terminal; and
b. a light transmitter configured to send a light signal indicating product identification upon receipt of product identification information from a reader, wherein the system is configured to superimpose product identification information on recorded video footage.

According to a still further exemplary embodiment there is provided a product identification verification device including an input for receiving a signal from a reading device and a radio transmitter which transmits RF signals based on signals received from the reading device.

According to a yet further exemplary embodiment there is provided a product identification verification device including an input for receiving a signal from a reading device and a non-visible light transmitter which transmits light signals based on signals received from the reading device.

According to a yet further exemplary embodiment there is provided a recording system for recording video data supplied to a first input including a video recorder and an RF receiver for receiving product identification information wherein the recording system superimposes the product identification information onto recorded video data as it is received.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a transaction terminal monitoring system according to a first embodiment;

FIG. 2 shows a product identification verification device suitable for use with the system of the first embodiment shown in FIG. 1;

FIG. 3 shows a transaction terminal monitoring system according to a second embodiment;

FIG. 4 shows a product identification verification device suitable for use with the system of the second embodiment shown in FIG. 3; and

FIGS. 5a to 5d show a product identification verification device according to a first embodiment.

FIG. 6 shows a product identification verification device according to a second embodiment.

### DETAILED DESCRIPTION OF EMBODIMENTS OF THE INVENTION

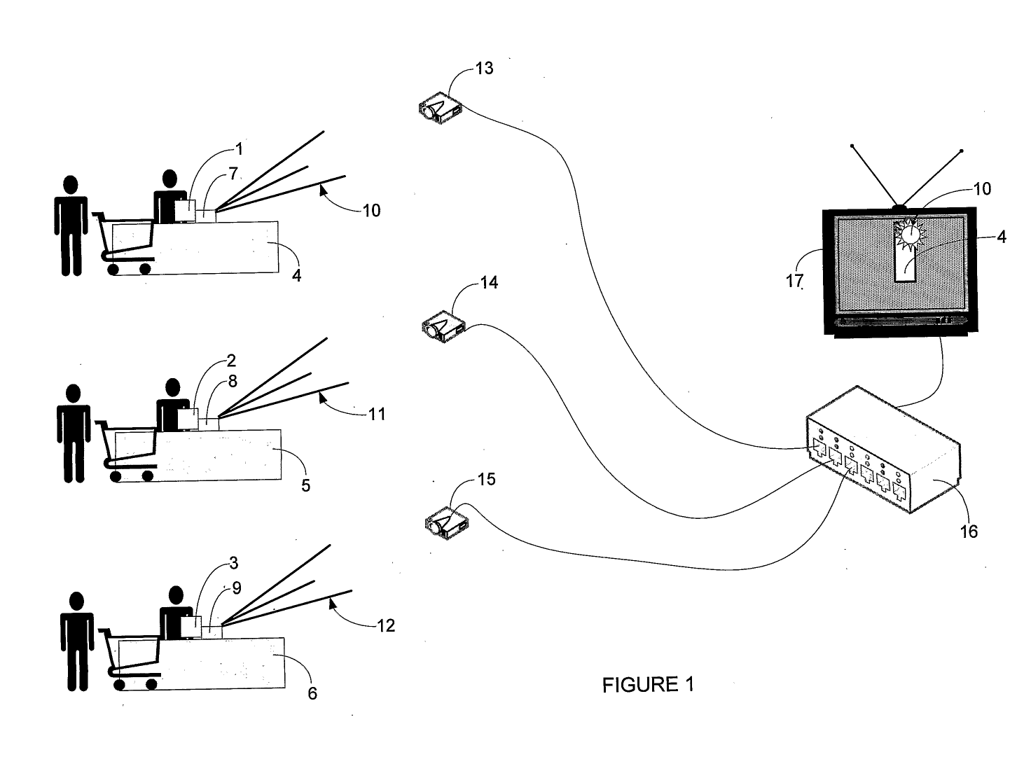

The transaction terminal monitoring system may be implemented using light signals or wireless signals. FIG. 1 shows an embodiment in which light signals are employed. In this exemplary embodiment, three transaction terminals 1, 2 and 3 are shown at three sales counters, 4, 5 and 6. It will be appreciated that the invention can be deployed with any number of counters as required. When an item at a counter is scanned by the respective transaction terminal 1, 2 or 3 a signal is sent to product identification signal transmitter 7, 8 or 9 respectively. In a preferred embodiment a signal from an EAS port of a transaction terminal 1, 2 or 3 is conveyed via a cable to a respective product identification signal transmitter 7, 8 or 9. It will be appreciated that the product identification signal transmitter 7, 8 or 9 could be incorporated within the transaction terminal 1, 2 or 3 or otherwise linked. Using the EAS port simplifies installation with pre-existing transactions terminals.

In this embodiment product identification signal transmitters 7, 8 and 9 emit light signals 10, 11 and 12 respectively when a signal is received from an EAS port of a respective transaction terminal 1, 2 or 3 indicating product identification. The light signal may have a user defined persistence. In the embodiment shown, respective video cameras 13, 14 and 15, monitor transaction terminals 1, 2 and 3 respectively. Video footage from video cameras 13, 14 and 15 is supplied to a video recording device 16 which records footage of transactions at each transaction terminal 1, 2 and 3 which may be displayed on a video display device 17. In FIG. 1 display device 17 currently displays a transaction at counter 4. Light 10 is illuminated indicating a positive product identification. A supervisor viewing video footage (either live or playing recorded footage) associated with transaction terminal 1 can thus see an operator scanning an item at a transaction terminal in combination with a light signal 10 indicating positive identification. The light signal may be a visible light signal. This enables the system to be easily deployed with existing cameras which can detect light at a visible range. However, a covert option may also be deployed using near infra-red light. In this embodiment product identification signal transmitters 7, 8 and 9 emit near infra-red light upon receiving a signal indicating a positive scan from the EAS port of a transaction terminal 1, 2 or 3. Cameras 13, 14 and 15 are capable of detecting near infra-red light and recording device 16 is capable of displaying the near infra-red light 10, 11 or 12 as a visible signal on display 17. Video recording device 16 may utilise any suitable recording media such as tape, optical disk, hard disk, silicon memory, etc.

It will be appreciated that video recording device 16 may combine video signals from cameras 13, 14 and 15 to superimpose recordings for a number of counters on each frame or they may be recorded as separate video streams. FIG. 1 illustrates an embodiment in which separate video streams are recorded. The frame rate should be above 1 frame per second and will preferably be about 3 to 4 frames per second.

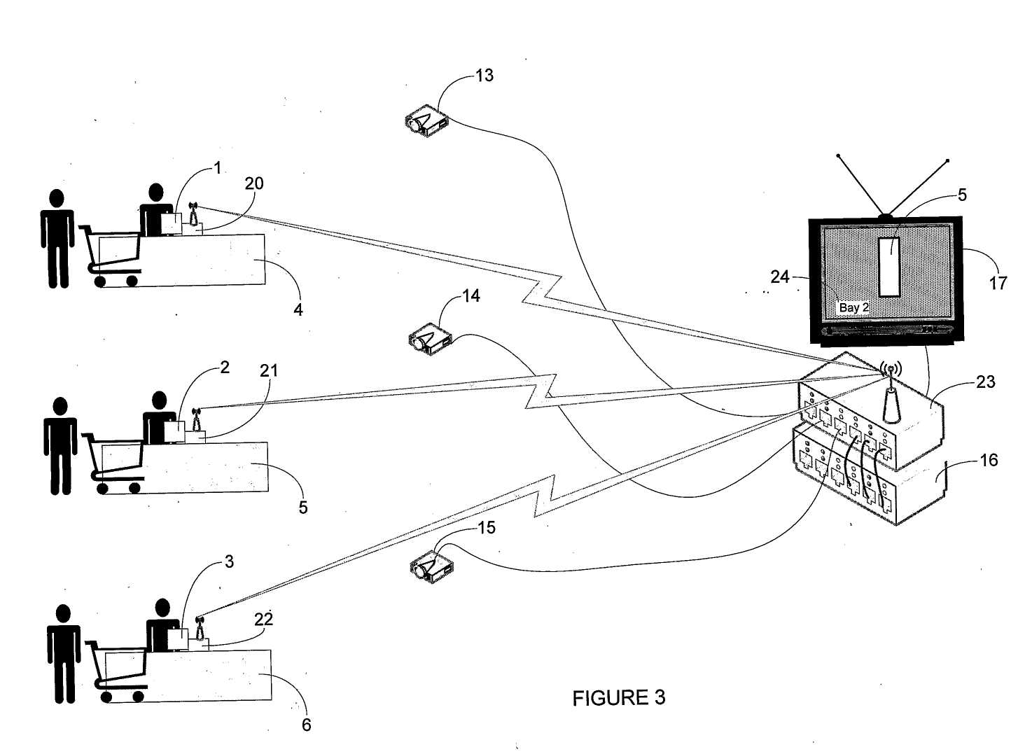

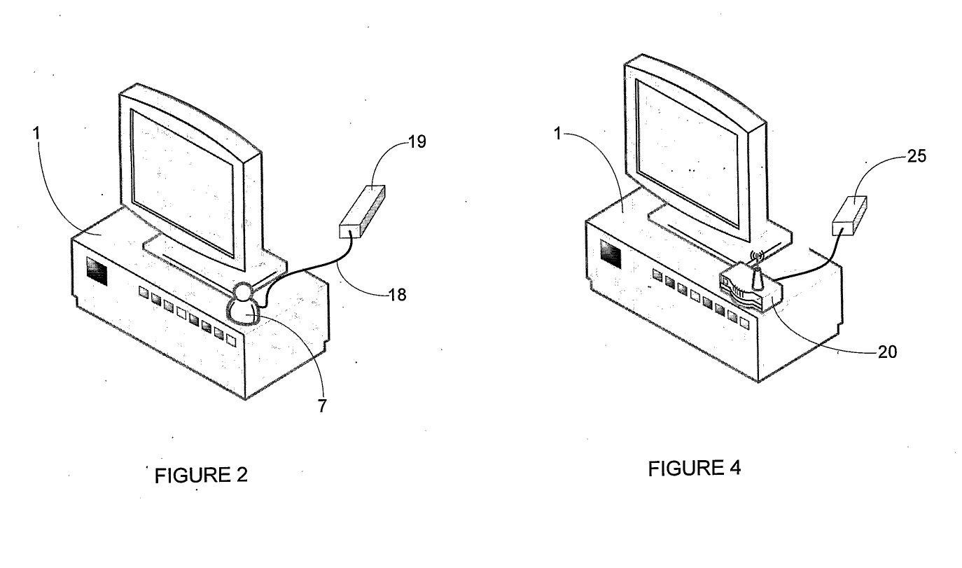

FIG. 2 shows a transaction terminal 1 and a product identification signal transmitter 7 in more detail. Product identification signal transmitter 7 may have a cable 18 connected to “pass-through” plug 19. Plug 19 may connect to an EAS port of transaction terminal 1 allowing another EAS plug to be plugged into the back of plug 19. This allows the system to be deployed without any loss of ports at the transaction terminal. Product identification signal transmitter 7 may also include a plug to another port of transaction terminal 1 to power the device, such as a USB port. This connection may also be by way of a “pass-through” port. Transaction terminal 1 will have an associated reading device which may be a portable bar code reader, fixed bar code reader, RFID reader, or any other suitable reading device.

The implementation according to this first embodiment has the advantage that it requires only the product identification signal transmitter to be deployed in conjunction with pre-existing video surveillance systems. This makes this embodiment particularly inexpensive and simple to deploy.

Referring now to FIG. 3 an alternative embodiment is shown in which a wireless communication system is employed. In FIG. 3 like elements have been given like numbering to those shown in FIG. 1. In this embodiment the product identification signal transmitters 7, 8 and 9 have been replaced with wireless product information signal transmitters 20, 21 and 22. The wireless transmitters 20, 21 and 22 receive signals from the EAS ports of the transaction terminals 1, 2 and 3 as in the embodiment shown in FIG. 1 but in this case transmit wireless signals to wireless receiver 23. The wireless transmitters 20, 21 and 22 may transmit information identifying the transmitter. Each time a positive product identification signal is received each wireless transmitter 20, 21 and 22 transmits a signal indicating positive product identification. This is received by receiving unit 23, combined with video footage and supplied to video recording unit 16. Receiving unit 23 may store details of the transaction terminal associated with each transmitter as well as site information etc. and superimposes this information onto video footage associated with the respective transaction terminal. As shown in FIG. 3 the text “bay 2” indicated by numeral 24 is superimposed onto the video footage associated with transaction terminal 2. The position, colour, size and location of text may be set as required by user. The period of persistence of the text box 24 may also be set by a user.

Referring now to FIG. 4 it will be seen that as in FIG. 2 the wireless product identification signal transmitter 20 may be interfaced to an EAS port of transaction terminal 1 via “pass-through” EAS plug 25. As with the embodiment shown in FIG. 2, another plug may be provided to obtain power from transaction terminal 1, such as a “pass-through” USB plug.

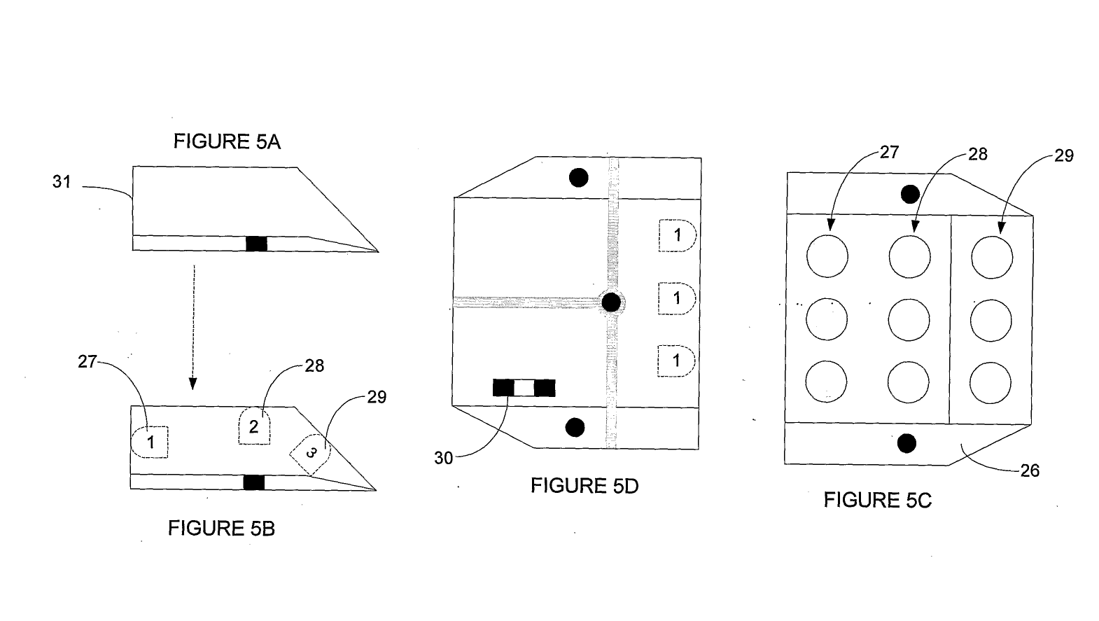

Referring to FIGS. 5a to 5d one design of product identification light signal transmitter is shown. Upon a base 26 three rows of light emitting elements 27, 28 and 29 (such as LEDs) are mounted. By adjusting the position of a three position switch 30 on the base of the unit, respective rows 27, 28 and 29 may be selected. This allows the row of light emitting elements best orientated towards a camera to be selected or visible or near infra-red elements to be selected. A transparent cover 31 may be provided over the base 26. The unit may be mounted flat or vertical by way of adhesive or other suitable mounting attachment.

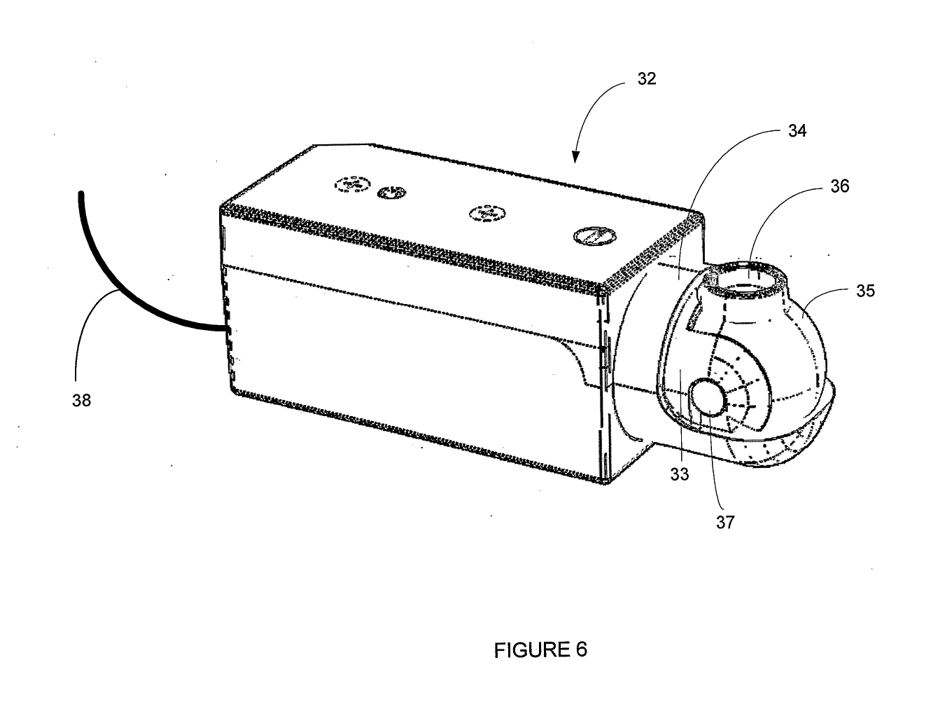

Referring now to FIG. 6 an alternative embodiment is shown in which a product identification verification unit 32 has a sleeve 34 at one end containing a mount 33 that is rotatable about the longitudinal axis of the unit. A lamp 35 has an aperture 36 allowing light from the lamp to be directed as required. Lamp 35 is rotatable about pins 37 (only one of which is shown) to allow rotation about an axis transverse to the longitudinal axis of the unit 32.

This allows rotation of light box 35 over a 90° range in the vertical plane and a 180° range in the horizontal plane. This allows light emitted from aperture 36 to be easily directed towards a monitoring camera. As in the previous embodiments an EAS signal is supplied via line 38 to trigger activation of a visible or non-visible light in lamp 35.

It will thus be seen that there is provided an inexpensive and simple mechanism to enable retailers to confirm positive product identification at transaction terminals.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method of monitoring product identification at a transaction terminal comprising:
a. identifying a product using a reader at a transaction terminal;
b. recording video footage of the reading of the product at the transaction terminal;
c. covertly sending information indicating product identification to a remote recording device; and
d. recording the video footage at the remote recording device in combination with information indicating product identification.

2. A method as claimed in claim 1 wherein the reader is a bar code reader.

3-49. (canceled)

50. A method as claimed in claim 1 wherein information indicating product identification is sent to the remote recording device when a signal indicating positive identification is detected at an EAS port of the reader.

51. A method as claimed in claim 1 wherein a radio signal is sent when a product is identified at a terminal and when received at the remote recording device information indicating product identification is recorded in combination with video footage of the transaction terminal.

52. A method as claimed in claim 51 wherein text is overwritten on the video footage indicating product identification.

53. A method as claimed in claim 1 wherein a plurality of transaction terminals are monitored and the remote recording device includes a multiplexer which receives information indicating product identification relating to the transaction terminals and superimposes it on the video footage.

54. A method as claimed in claim 1 wherein the information indicating product identification is sent as a non-visible light signal.

55. A method as claimed in claim 54 wherein the light signal is a near infra-red light signal.

56. A method as claimed in claim 54 wherein a light sending unit is located in close proximity with each transaction terminal so that light signals may be easily associated with a transaction terminal.

57. A transaction terminal monitoring system comprising:
e. a video recording device for recording video footage of a transaction terminal;
f. a wireless transmitter configured to send a wireless signal indicating product identification upon receipt of product identification information from a reader; and
g. a wireless receiver configured to receive product identification information signals from the wireless transmitter, wherein the system is configured to superimpose product identification information on recorded video footage.

58. A system as claimed in claim 57 wherein the wireless transmitter is configured to send a wireless signal indicating product identification upon receipt of an EAS signal from a port of a transaction terminal.

59. A transaction terminal monitoring system comprising:
h. a video recording device for recording video footage of a transaction terminal; and
i. a light transmitter configured to send a light signal indicating product identification upon receipt of product identification information from a reader, wherein the system is configured to superimpose product identification information on recorded video footage.

60. A system as claimed in claim 59 wherein the light transmitter is configured to send a light signal indicating product identification upon receipt of an EAS signal from a port of a transaction terminal.

61. A system as claimed in claim 60 wherein the light transmitter includes a pass-through plug connecting to the EAS terminal of a transaction terminal.

62. A system as claimed in claim 59 wherein the light transmitter includes a cable to connect to a port of a transaction terminal to power the light transmitter.

63. A system as claimed in claim 59 wherein the light transmitter emits visible light.

64. A system as claimed in claim 59 wherein the light transmitter emits near infra-red light.

65. A product identification verification device including an input for receiving a signal from a reading device and a radio transmitter which transmits RF signals based on signals received from the reading device.

66. A product identification verification device as claimed in claim 65 wherein the RF signal includes an identification code for a terminal associated with the device.

67. A product identification verification device including a body, an input for receiving a signal from a reading device and a lamp which transmits light signals based on signals received from the reading device, wherein the lamp may be articulated about two orthogonal axes with respect to the body.
